(19) United States
(12) Patent Application Publication
(10) Pub. No.: US 2018/0361442 A1
(43) Pub. Date: Dec. 20, 2018

(54) System and Method for Cleaning Mud Tank

(71) Applicant: Schlumberger Norge AS, Tananger (NO)

(72) Inventors: Sigleif Engen, Tananger (NO); Frank Eriksen, Sandnes (NO)

(21) Appl. No.: 16/062,086

(22) PCT Filed: Dec. 15, 2016
(86) PCT No.: PCT/US2016/066776

§ 371 Date: Jun. 13, 2018

Related U.S. Application Data
(60) Provisional application No. 62/269,069, filed on Dec. 17, 2015.

(51) Int. Cl. B08B 9/093; B01D 21/02; C02F 1/00

(52) U.S. Cl. CPC B08B 9/0933; B01D 21/02; B08B 2209/08; C02F 2001/007; C02F 2201/008; C02F 1/00

(57) ABSTRACT

A system for cleaning a tank includes four tanks. The first tank stores a processed liquid. The second tank is in fluid communication with the first tank. The second tank includes a separator that separates particles from a dirty liquid to produce the processed liquid. The processed liquid is transferred from the second tank into the first tank. The third tank is in fluid communication with the second tank. The particles are transferred from the second tank to the third tank. The fourth tank stores a clean liquid. The clean liquid has fewer particles per unit volume than the processed liquid. The first tank, the second tank, the third tank, and the fourth tank are positioned on a mobile unit.

### CROSS-REFERENCE TO RELATED APPLICATION

The present document is based on and claims priority to U.S. Provisional Application Ser. No.: 62/269,069, filed Dec. 17, 2015, which is incorporated herein by reference in its entirety.

### BACKGROUND

A platform supply vessel (“PSV”) is a ship that is designed to transport goods, tools, equipment, and personnel to and from offshore oil platforms. The PSV may also include a tank for holding fluids used during the drilling, completion, and/or production processes at the oil platform. The fluids may be or include drilling fluid (e.g., mud) that is pumped into a wellbore, hydrocarbons produced from the wellbore, a combination thereof. These fluids may accumulate on the walls of the tank over time. As a result, the tank is occasionally cleaned.

The tank may be cleaned manually from the inside. In other words, a person may climb into the tank. The person may spray the sides of the tank with water ejected out of a pressure washer. Oftentimes, however, the tank may be so large that a person may not be able to reach some of the surfaces with the pressure washer without erecting scaffolding inside the tank. As will be appreciated, erecting scaffolding inside a tank on a PSV may take a considerable amount of time and money.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a schematic view of system for cleaning a tank, according to an embodiment.

FIG. 2 illustrates a flowchart of a method for cleaning the tank, according to an embodiment.

### DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the systems and methods disclosed herein may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the present disclosure. The first object and the second object are both objects, but they may not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Examples of processing procedures, methods, techniques, and workflows are disclosed and described in accordance with one or more embodiments of the disclosure, however, those of ordinary skill in the art will appreciate other procedures, techniques or workflows that can be used instead of these or in addition to these. Some operations in the processing procedures, methods, techniques, and workflows disclosed herein may be combined and/or the order of some operations may be changed.

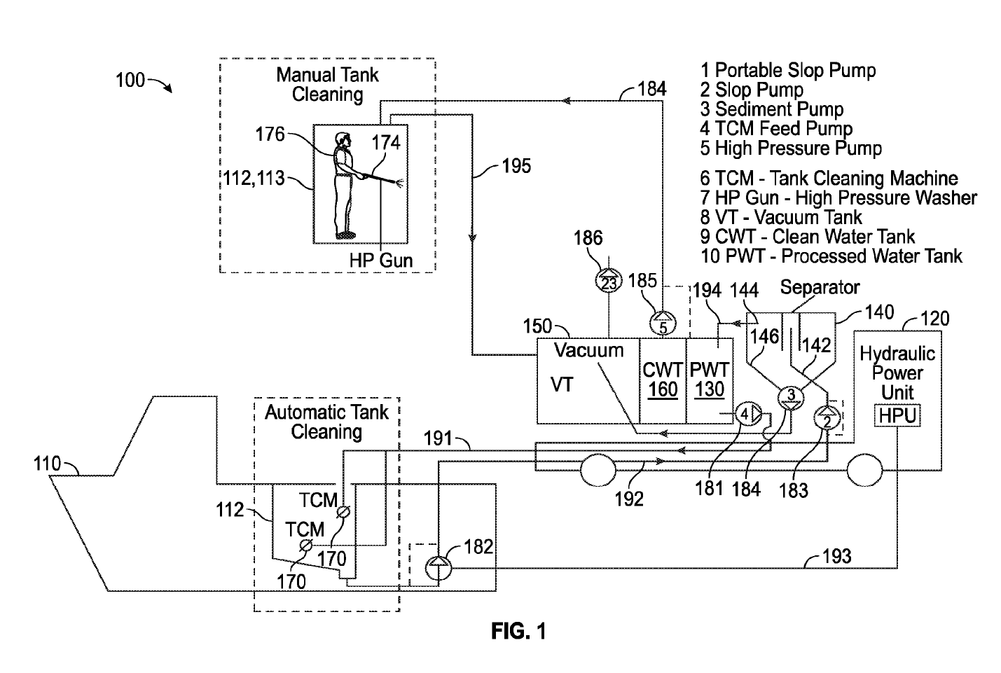

FIG. 1 illustrates a schematic view of system 100 for cleaning a tank 112, according to an embodiment. As shown, the tank to be cleaned 112 may be on a boat 110 (e.g., a platform supply vessel). In other embodiments, the tank to be cleaned 112 may be on a truck, in a building, underground, etc. In one embodiment, the tank to be cleaned 112 may have particles from fluids used during drilling, completion, and/or production process(es) adhered to the interior surfaces thereof. The particles may be or include weighing material, barite, mud, sand, drill cuttings, or a combination thereof.

The system 100 may include a mobile unit 120. The mobile unit 120 may be or include a car, a truck (as shown), a boat, a helicopter, or the like. As such, the mobile unit 120 may be able to be moved (e.g., driven, flown, etc.) to within a predetermined distance from the tank to be cleaned 112. The predetermined distance may be less than or equal to about 200 meters, less than or equal to about 100 meters, or less than or equal to about 50 meters.

The mobile unit 120 may include one or more tanks (four are shown: 130, 140, 150, 160). The first tank 130 may store a liquid. The liquid in the first tank 130 may be a “clean” liquid, a “processed” liquid, or a combination thereof. For example, the liquid in the first tank 130 may initially be a clean liquid, and may subsequently become a processed liquid, as described in greater detail below. In some embodiments, the first tank 130 may be referred to as a processed water tank (“PWT”). The first tank 130 may serve as a buffer because the dirty water may have in irregular flow without the first tank 130.

As used herein, a “clean liquid” refers to a liquid having fewer particles per unit volume than the processed liquid. For example, the clean liquid may have less than or equal to about 0.2 vol % particles. As used herein, a “processed liquid” refers to a liquid that has had particles removed therefrom while in the second tank 140, as discussed in greater detail below. The processed liquid may have less than or equal to about 1.0 vol % particles.

The clean liquid and/or the processed liquid may be or include water. In some embodiments, the clean liquid and/or the processed liquid may also include one or more chemicals designed to help remove the particles from the interior surfaces of the tank to be cleaned 112. The chemicals may be or include soap, detergent, degreaser, surfactant, defoamer, or a combination thereof.

The second tank 140 may be (at least a part of) an automatic tank cleaning (“ATC”) unit. As such, the second tank 140 may be or include a separator. As shown, the second tank 140 may include one or more inlets (one is shown: 142) and one or more outlets (two are shown: 144, 146). As described in greater detail below, a “dirty” liquid (also known as “slop”) may be introduced into the second tank 140 through the inlet 142. As used herein, a “dirty liquid” refers to a liquid that is pumped from the tank to be cleaned 112 into the second tank 140. In some embodiments, the dirty liquid may have greater than about 3 vol % of particles.

The particles may be separated from the dirty liquid in the second tank 140 to produce (1) the processed liquid and (2) the particles. The separation may be gravity-induced. The cleaning chemicals mentioned above may also accelerate the three-phase separation. In at least one embodiment, after separation occurs, the particles may be positioned below the processed liquid within the second tank 140 because the particles may have a greater density than the processed liquid.

As described in greater detail below, the processed liquid may flow out of the first outlet 144 of the second tank 140 and into the first tank 130. The particles may be pumped out of the second outlet 146 of the second tank 140 and into the third tank 150. The third tank 150 may be used to store the particles from the second tank 140. In some embodiments, the third tank 150 may be referred to as a vacuum tank (“VT”).

The fourth tank 160 may be used to store clean liquid. In some embodiments, the fourth tank 160 may be referred to as a clean water tank (“CWT”). The clean liquid may be water. As mentioned above, the clean liquid in the fourth tank 160 may have fewer particles (e.g., per unit volume) than the processed liquid in the first tank 130.

The system 100 may also include one or more tank cleaning machines (“TCMs”; two are shown: 170). The tank cleaning machines 170 may be positioned within the tank to be cleaned 112 (e.g., on the boat 110). The clean and/or processed liquid may be pumped from the first tank 130 to the tank cleaning machines 170, and the tank cleaning machines 170 may spray the interior surfaces of the tank to be cleaned 112 with the clean and/or processed liquid. The tank cleaning machines 170 may move through a predetermined pattern (e.g., like an irrigation sprinkler) to clean multiple surfaces inside the tank to be cleaned 112. The clean and/or processed liquid flowing out of the tank cleaning machines 170 may have a flow rate from about 4 m³/hour (per nozzle) to about 20 m³/hour (per nozzle) and a pressure from about 6 bar to about 14 bar. As such, the clean and/or processed liquid flowing out of the tank cleaning machines 170 may be referred to as “high flow, low pressure.”

The system 100 may also include one or more pressure washers (one is shown: 174). The pressure washer 174 may be positioned within the tank to be cleaned 112 (e.g., on the boat 110) or in a different tank to be cleaned 113. The clean liquid may be pumped from the fourth tank 160 to the pressure washer 174, and the pressure washer 174 may be used to spray the interior surfaces of the tank to be cleaned 112 with the clean liquid. The pressure washer 174 may be operated manually (e.g., moved/aimed by a user 176). The clean liquid flowing out of the pressure washer 174 may have a flow rate from about 10 liters/minute to about 30 liters/minute and a pressure from about 100 bar to about 400 bar. As such, the clean liquid flowing out of the pressure washer 174 may be referred to as “low flow, high pressure.”

The system 100 may also include one or more pumps (six are shown: 181-186). The first pump 181 may cause the clean and/or processed liquid to flow from the first tank 130 to the tank cleaning machines 170 in the tank to be cleaned 112. As such, the first pump 181 may be referred to as a TCM feed pump. The first pump 181 may be positioned on the mobile unit 120. The second pump 182 may cause the dirty liquid to flow from the tank to be cleaned 112 into the second tank 140 on the mobile unit 120. As such, the second pump 182 may be referred to as a portable slop pump. The second pump 182 may be positioned on the boat 110. The third pump 183 may also cause the dirty liquid to flow from the tank to be cleaned 112 into the second tank 140 on the mobile unit 120. As such, the third pump 183 may be referred to as a slop pump. The third pump 183 may be positioned on the mobile unit 120. The fourth pump 184 may cause the particles to flow from the second tank 140 into the third tank 150. As such, the fourth pump 184 may be referred to as a particle/sediment pump. The fourth pump 184 may be positioned on the mobile unit 120. The fifth pump 185 may cause the clean liquid to flow from the fourth tank 160 to the pressure washer 174 in the tank to be cleaned 112. As such, the fifth pump 185 may be referred to as a high pressure pump. The fifth pump 185 may be positioned on the mobile unit 120. The sixth pump 186 may generate a vacuum effect in the third tank 150. As such, the sixth pump 186 may be referred to as a vacuum pump. The sixth pump 186 may be positioned on the mobile unit 120.

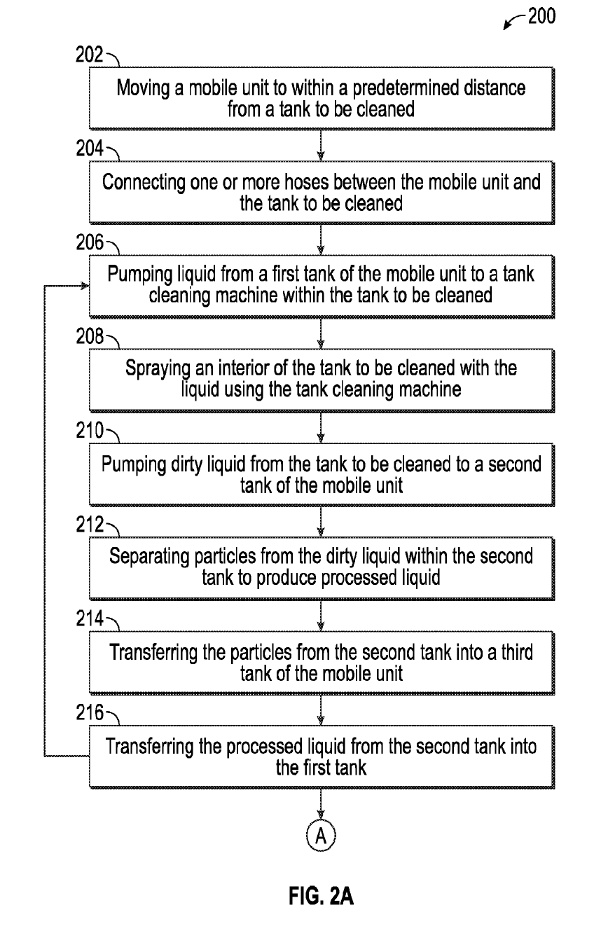

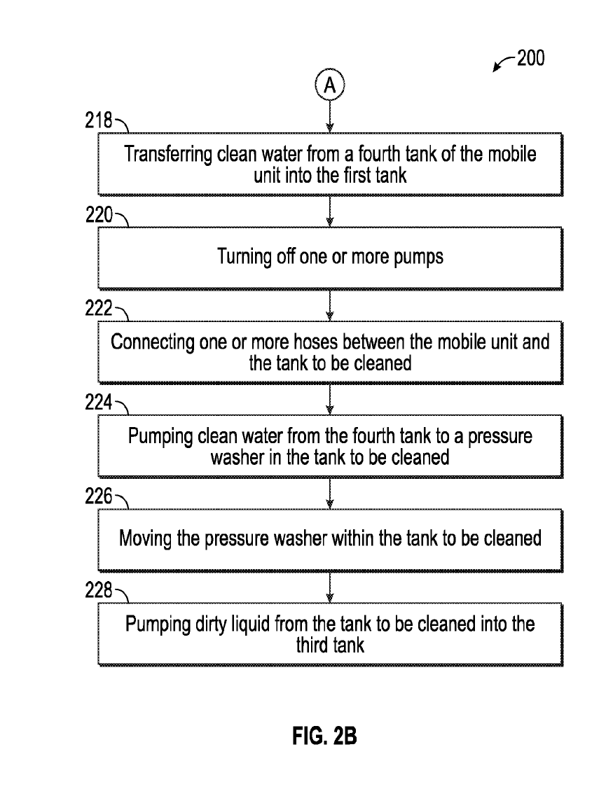

FIG. 2 illustrates a flowchart of a method 200 for cleaning the tank 112, according to an embodiment. The method 200 may be performed using the system 100 shown in FIG. 1. The method 200 may begin by moving (e.g., driving, flying, etc.) the mobile unit 120 to within a predetermined distance from the tank to be cleaned 112, as at 202.

The method 200 may then include connecting one or more hoses between the mobile unit 120 and the tank to be cleaned 112, as at 204. As shown in FIG. 1, the hoses may include a first hose 191 between the first (e.g., processed water) tank 130 and the tank to be cleaned 112. The hoses may also include a second hose 192 between the tank to be cleaned 112 and the second (e.g., separator) tank 140. The hoses may also include a third hose 193 between the tank to be cleaned 112 and a hydraulic power unit on the mobile unit 120.

The method 200 may then include pumping (clean and/or processed) liquid from the first (e.g., processed water) tank 130 to the tank cleaning machines 170 that is positioned in the tank to be cleaned 112, as at 206. The liquid may be pumped by the first pump 181 through the first hose 191.

The method 200 may then include spraying an interior of the tank to be cleaned 112 with the liquid using the tank cleaning machines 170, as at 208. This may dislodge particles that were adhered to the interior surfaces of the tank to be cleaned 112, and the particles and the processed liquid may accumulate in the bottom of the tank to be cleaned 112, forming the dirty liquid.

The method 200 may then include pumping the dirty liquid from the tank to be cleaned 112 to the second (e.g., separator) tank 140, as at 210. The dirty liquid may be pumped by the second and/or third pumps 182, 183 through the second hose 192.

The method 200 may also include separating the particles and heavy liquid (e.g., mud) from the dirty liquid within the second (e.g., separator) tank 140 to produce additional processed liquid, as at 212. The separating at 212 may occur simultaneously with the pumping at 206, the spraying at 208, the pumping at 210, or a combination thereof.

The method 200 may also include transferring (e.g., pumping) the particles and heavy liquid from the second (e.g., separator) tank 140 into the third (e.g., vacuum) tank 150, as at 214. The particles and heavy liquid may be transferred in the form of a slurry including some of the processed liquid. The particles may be pumped by the fourth pump 184. The transferring at 214 may occur simultaneously with the pumping at 206, the spraying at 208, the pumping at 210, the separating at 212, or a combination thereof.

The method 200 may also include transferring the separated processed liquid from the second (e.g., separator) tank 140 into the first (e.g., processed water) tank 130, as at 216. The separated process liquid may be “self-draining” into the first tank 130 via hose 194. The transferring at 216 may occur simultaneously with the pumping at 206, the spraying at 208, the pumping at 210, the separating at 212, the transferring at 214, or a combination thereof.

The method 200 may then loop back around to pumping the processed liquid from the first (e.g., processed water) tank 130 to the tank cleaning machines 170 in the tank to be cleaned 112, as at 206. As the method loops through 202-216, the level of processed water in the first (e.g., processed water) tank 130 may gradually decrease, as some of the processed water may flow with the particles into the third (e.g., vacuum) tank 150. Thus, in some embodiments, the method 200 may include transferring clean water from the fourth (e.g., clean water) tank 160 into the first (e.g., processed water) tank 130, as at 218. This may occur, for example, when the level of processed liquid in the first (e.g., processed water) tank 130 drops below a predetermined amount. The clean water may be transferred using the fifth pump 185. The transferring at 216 may occur simultaneously with the pumping at 206, the spraying at 208, the pumping at 210, the separating at 212, the transferring at 214, the transferring at 216, or a combination thereof.

The foregoing portion of the method 200 may continue for a predetermined amount of time and/or until a user determines that the tank cleaning machine 170 has cleaned a predetermined portion of the interior of the tank to be cleaned 112. At this time, the method 200 may include turning off one or more of the pumps 181-184, as at 220. When the pump(s) 181-184 is/are turned off, no processed liquid flows out of the tank cleaning machine 170. As will be appreciated, some particles may remain adhered to the interior of the tank to be cleaned 112 despite being sprayed by the tank cleaning machine 170. In addition, the spray from the tank cleaning machine 170 may miss portions of the interior of the tank to be cleaned 112. To remove these remaining particles, the method 200 may continue as described below.

After the one or more pumps 181-184 is/are turned off, the method 200 may include connecting one or more hoses between the mobile unit 120 and the tank to be cleaned 112, as at 222. The hoses may include a fourth hose 194 between the fourth tank 160 on the mobile unit 120 and the tank to be cleaned 112. The hoses may also include a fifth hose 195 between the tank to be cleaned 112 and the third tank 150 on the mobile unit 120.

The method 200 may also include pumping clean water from the fourth (e.g., clean water) tank 160 to the pressure washer 174 in the tank to be cleaned 112, as at 224. The clean water may be pumped by the fifth pump 185 through the fourth hose 194.

The method 200 may also include moving the pressure washer 174 within the tank to be cleaned 112 with the user 176, as at 226. More particularly, the user 176 may identify (e.g., visually) the portions of the interior of the tank to be cleaned 112 that still have particles adhered thereto, and the user may direct the clean water sprayed out of the pressure washer 174 to those portions of the interior of the tank to be cleaned 112. This may dislodge the remaining particles that were adhered to the interior surfaces of the tank to be cleaned 112, and the particles and the clean liquid may accumulate in the bottom of the tank to be cleaned 112, forming additional dirty liquid.

The method 200 may then include pumping the additional dirty liquid from the tank to be cleaned 112 to the third (e.g., vacuum) tank 150, as at 228. More particularly, the sixth pump 186 may generate a vacuum effect in the third tank 150, which may pull the additional dirty liquid from the tank to be cleaned 112 into the third tank 150. The additional dirty liquid may flow through the fifth hose 195. The pumping at 228 may occur simultaneously with the pumping at 224, the moving at 226, or both.

Thus, as will be appreciated, the tank to be cleaned 112 may first be cleaned with the tank cleaning machines 170 and subsequently be cleaned by the user 176 and the pressure washer 174. In another embodiment, the tank cleaning machines 170 may clean the tank to be cleaned 112 while the user 176 and the pressure washer 174 simultaneously clean a separate tank (e.g., tank 113). In this embodiment, the third (e.g., vacuum) tank 160 may receive the particles from the second (e.g., separator) tank 140 and the dirty liquid from the tank 112 or 113 simultaneously.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

The following is claimed:

1. A system for cleaning a tank, comprising:
a first tank configured to store a processed liquid;
a second tank in fluid communication with the first tank, wherein the second tank comprises a separator that is configured to separate particles from a dirty liquid to produce the processed liquid, wherein the processed liquid is transferred from the second tank into the first tank;
a third tank in fluid communication with the second tank, wherein the particles are transferred from the second tank to the third tank; and
a fourth tank configured to store a clean liquid, wherein the clean liquid has fewer particles per unit volume than the processed liquid, and wherein the first tank, the second tank, the third tank, and the fourth tank are positioned on a mobile unit.

2. The system of claim 1, further comprising a tank cleaning machine configured to be positioned within a tank to be cleaned.

3. The system of claim 2, further comprising a first pump positioned on the mobile unit, wherein the first pump is configured to cause the processed liquid to flow from the first tank to the tank cleaning machine.

4. The system of claim 3, wherein the tank cleaning machine is configured to spray an interior surface of the tank to be cleaned with the processed liquid, thereby removing the particles from the interior surface, wherein the particles become dispersed within the processed liquid in the tank to be cleaned to produce the dirty liquid in the tank to be cleaned.

5. The system of claim 4, further comprising a second pump configured to cause the dirty liquid to flow from the tank to be cleaned to the second tank.

6. The system of claim 5, wherein the tank to be cleaned is on a boat, and wherein the second pump is positioned on the boat.

7. The system of claim 5, wherein the second pump is positioned on the mobile unit.

8. The system of claim 5, further comprising a pressure washer configured to be positioned within the tank to be cleaned.

9. The system of claim 8, further comprising a third pump positioned on the mobile unit, wherein the third pump is configured to cause the clean liquid to flow from the fourth tank to the pressure washer.

10. The system of claim 9, wherein the pressure washer is configured to spray the interior surface of the tank to be cleaned with the clean liquid, thereby removing the particles from the interior surface, and wherein the particles become dispersed within the clean liquid in the tank to be cleaned to produce the dirty liquid in the tank to be cleaned.

11. A method for cleaning a tank, comprising:
pumping a processed liquid from a first tank on a mobile unit to a tank cleaning machine that is positioned within a tank to be cleaned;
spraying an interior surface of the tank to be cleaned with the processed liquid using the tank cleaning machine, wherein the processed liquid dislodges particles that are adhered to the interior surface, and wherein the particles become dispersed within the processed liquid to produce a dirty liquid within the tank to be cleaned;
pumping the dirty liquid from the tank to be cleaned to a second tank on the mobile unit;
separating the particles from the dirty liquid within the second tank to produce additional processed liquid;
transferring the additional processed liquid from the second tank into the first tank;
transferring the particles from the second tank into a third tank on the mobile unit;
pumping a clean liquid from a fourth tank on the mobile unit to a pressure washer that is positioned within the tank to be cleaned; and
spraying the interior surface of the tank to be cleaned with the clean liquid using the pressure washer.

12. The method of claim 11, further comprising moving the mobile unit to within a predetermined distance from the tank to be cleaned.

13. The method of claim 11, wherein the clean liquid has fewer particles per unit volume than the processed liquid.

14. The method of claim 11, wherein the interior surface of the tank to be cleaned is sprayed with the clean liquid after the interior surface of the tank to be cleaned is sprayed with the processed liquid.

15. The method of claim 11, further comprising transferring at least a portion of the clean liquid from the fourth tank into the first tank.

16. The method of claim 11, further comprising moving the pressure washer within the tank to be cleaned with a user.

17. The method of claim 11, wherein the clean liquid dislodges additional particles that are adhered to the interior surface, and wherein the additional particles become dispersed within the clean liquid to produce additional dirty liquid within the tank to be cleaned.

18. The method of claim 17, further comprising pumping the additional dirty liquid from the tank to be cleaned to the third tank on the mobile unit.

19. The method of claim 11, wherein the tank to be cleaned is on a boat.

20. A method for cleaning a tank, comprising:
moving a mobile unit to within a predetermined distance from a tank to be cleaned;
pumping a processed liquid from a first tank on the mobile unit to a tank cleaning machine that is positioned within the tank to be cleaned;
spraying an interior surface of the tank to be cleaned with the processed liquid using the tank cleaning machine, wherein the processed liquid dislodges particles that are adhered to the interior surface, and wherein the particles become dispersed within the processed liquid to produce a dirty liquid within the tank to be cleaned;
pumping the dirty liquid from the tank to be cleaned to a second tank on the mobile unit;
separating the particles from the dirty liquid within the second tank to produce additional processed liquid;
transferring the additional processed liquid from the second tank into the first tank;
transferring the particles from the second tank into a third tank on the mobile unit;
transferring a portion of a clean liquid from a fourth tank on the mobile unit into the first tank, wherein the clean liquid has fewer particles per unit volume than the processed liquid;
pumping another portion of the clean liquid from the fourth tank to a pressure washer that is positioned within the tank to be cleaned;
spraying the interior surface of the tank to be cleaned with the clean liquid using the pressure washer after the interior surface of the tank to be cleaned is sprayed with the processed water using the tank cleaning machine; and
moving the pressure washer within the tank to be cleaned with a user.
